(19) United States
(12) Patent Application Publication
(10) Pub. No.: US 2025/0040623 A1
(43) Pub. Date: Feb. 6, 2025

(54) AEROSOL PROVISION DEVICE COMPRISING TWO CHARGING MODULES

(71) Applicant: NICOVENTURES TRADING LIMITED, London (GB)

(72) Inventors: Mohammed AL-AMIN, London (GB); Damyn MUSGRAVE, London (GB)

(21) Appl. No.: 18/717,766

(22) PCT Filed: Dec. 8, 2022
(86) PCT No.: PCT/GB2022/053140

§ 371 Date: Jun. 7, 2024

(30) Foreign Application Priority Data
Dec. 9, 2021 (GB) 2117825.6

(51) Int. Cl. A24F 40/90; A24F 40/51; A24F 40/53; A24F 40/60; A24F 40/65; H01M 10/44; H02J 7/00; H02J 50/10; H02J 50/20

(52) U.S. Cl. CPC A24F 40/90; A24F 40/51; A24F 40/53; A24F 40/60; A24F 40/65; H01M 10/44; H02J 7/00032; H02J 50/10; H02J 50/20; H01M 2220/30

(57) ABSTRACT

An aerosol provision device is described comprising: an antenna; a battery; a first charging module, configured to selectively charge the battery with power extracted from radio frequency signals received using the antenna; a second charging module, configured to selectively charge the battery with power obtained from a second source; and a control module configured to control the first and second charging modules, thereby controlling charging of the battery. A method and apparatus for charging said aerosol provision device is also described.

### TECHNICAL FIELD

The present specification relates to charging an aerosol provision device.

### BACKGROUND

Smoking articles, such as cigarettes, cigars and the like burn tobacco during use to create tobacco smoke. Attempts have been made to provide alternatives to these articles by creating products that release compounds without combusting. For example, tobacco heating devices heat an aerosol provision substrate such as tobacco to form an aerosol by heating, but not burning, the substrate. There remains a need for further developments in this field.

### SUMMARY

In a first aspect, this specification describes an aerosol provision device comprising: an antenna; a battery; a first charging module, configured to selectively charge the battery with power extracted from radio frequency signals received using the antenna; a second charging module, configured to selectively charge the battery with power obtained from a second source; and a control module configured to control the first and second charging modules, thereby controlling charging of the battery. The antenna may be configured to transmit and/or receive data.

The control module may be configured to determine whether the first charging module is capable of charging the battery and, if so, whether the first charging module is to be used to charge the battery. Alternatively, or in addition, the control module may be configured to determine whether the second charging module is capable of charging the battery and, if so, whether the second charging module is to be used to charge the battery.

The control module may be configured to determine whether to charge the battery using the first charging module, the second charging module, or both.

The control module may be configured to select a preferential source of power.

In some example embodiments, the aerosol provision device further comprises: at least one power detection unit, wherein the at least one power detection unit is configured to determine whether power is obtainable using the first charging module and/or the second charging module and communicate a signal indicative of the above determination to the control module. The at least one power detection unit may comprise a first power detection unit configured to: determine a first the amount of power extracted from the first charging module; and communicate information relating to the first amount of power to the control module. Alternatively, or in addition, the at least one power detection unit may comprise a second power detection unit configured to: determine a second amount of power extracted from the second charging module; and communicate information relating to the second amount of power to the control module.

The aerosol provision device may further comprise: a user interface, wherein the user interface is configured to: enable the user to indicate whether power may be obtained using the first charging module and/or the second charging module; and communicate a signal indicative of the above user indication to the control module. The user interface may enable a user to select a preferential source of power.

In some example embodiments, the aerosol provision device further comprises an induction module, wherein the second charging module is configured to selectively charge the battery with power obtained by the induction module through electromagnetic induction. The aerosol provision device may further comprise a sensor (e.g. a proximity sensor) configured to detect whether the induction module is within the vicinity of a charging module so as to receive power through electromagnetic induction.

In a second aspect, this specification describes a method comprising: obtaining first electrical power from radio frequency signals using an antenna of an aerosol provision device; obtaining second electrical power from a second source; and selectively charging a battery of the aerosol provision device using the first and/or the second obtained electrical power.

The method may further comprise: determining whether a first charging module is capable of charging the battery with the first electrical power extracted from radio frequency signals using the antenna and, if so, whether the first charging module is to be used to charge the battery.

The method may further comprise: determining whether a second charging module is capable of charging the battery with the second electrical power and, if so, whether the second charging module is to be used to charge the battery.

The method may further comprise: determining whether to charge the battery using the first obtained electrical power, the second obtained electrical power, or both.

The method may further comprise selecting a preferential source of power. Furthermore, the method may further comprise receiving a user input indicating a preferential power source and selecting said preferential source of power accordingly.

In some example embodiments, obtaining second electrical power from the second source may comprise obtaining said second electrical power through electromagnetic induction using an induction module. The method may further comprise: determining whether power may be obtained using the antenna and/or the induction module using a power detection unit, and communicating a signal indicative of the above determination to the control module. The method may further comprise: monitoring the antenna and/or the induction unit; determining an amount of power extracted by the antenna and/or the induction unit; and communicating information relating to the extracted power to the control module. The method may further comprise: monitoring the antenna and/or the induction unit; determining an amount of power available to be extracted by the antenna and/or the induction unit; and communicating information relating to the extracted power to the control module. The method may further comprise: detecting whether the induction module is within the vicinity of a charging module so as to receive power through electromagnetic induction.

In a third aspect, the specification describes a computer program comprising instructions for causing an apparatus to perform a method as set out above with respect to the second aspect.

### BRIEF DESCRIPTION OF THE DRAWINGS

Example embodiments will now be described, by way of example only, with reference to the following schematic drawings, in which:

FIG. 1 is a block diagram of a non-combustible aerosol provision device in accordance with an example embodiment;

FIG. 2 is a block diagram of a system in accordance with an example embodiment;

FIG. 3 is a flow chart showing an algorithm in accordance with an example embodiment;

FIG. 4 is a block diagram of a system in accordance with an example embodiment;

FIGS. 5 to 7 are flow charts showing algorithms in accordance with example embodiments;

FIG. 8 is a block diagram of a system in accordance with an example embodiment;

FIG. 9 is a flow chart showing an algorithm in accordance with an example embodiment; and

FIG. 10 is a block diagram of a charging device in accordance with an example embodiment.

### DETAILED DESCRIPTION

As used herein, the term “delivery system” is intended to encompass systems that deliver at least one substance to a user, and includes non-combustible aerosol provision systems that release compounds from an aerosol-generating material without combusting the aerosol-generating material, such as electronic cigarettes, tobacco heating products, and hybrid systems to generate aerosol using a combination of aerosol-generating materials.

According to the present disclosure, a “combustible” aerosol provision system is one where a constituent aerosol-generating material of the aerosol provision system (or component thereof) is combusted or burned during use in order to facilitate delivery of at least one substance to a user.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In some embodiments, the substance to be delivered may be an aerosol-generating material or a material that is not intended to be aerosolised. As appropriate, either material may comprise one or more active constituents, one or more flavours, one or more aerosol-former materials, and/or one or more other functional materials.

In some embodiments, the substance to be delivered comprises an active substance. The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical. In one embodiment, the active substance is a legally permissible recreational drug. In some embodiments, the active substance comprises nicotine. In some embodiments, the active substance comprises caffeine, melatonin or vitamin B12. In some embodiments, the active substance comprises or is derived from one or more botanicals or constituents, derivatives or extracts thereof and the botanical is tobacco. In some embodiments, the substance to be delivered comprises a flavour.

Aerosol-generating material is a material that is capable of generating aerosol, for example when heated, irradiated or energized in any other way. Aerosol-generating material may, for example, be in the form of a solid, liquid or gel which may or may not contain an active substance and/or flavourants.

The aerosol-generating material may be an “amorphous solid”. In some embodiments, the amorphous solid is a “monolithic solid”. The aerosol-generating material may be non-fibrous or fibrous. In some embodiments, the aerosol-generating material may be a dried gel. The aerosol-generating material may be a solid material that may retain some fluid, such as liquid, within it. In some embodiments the retained fluid may be water (such as water absorbed from the surroundings of the aerosol-generating material) or the retained fluid may be solvent (such as when the aerosol-generating material is formed from a slurry). In some embodiments, the solvent may be water.

In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavours, one or more aerosol-former materials, and optionally one or more other functional material.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The material may be present on or in a support, to form a substrate. The support may, for example, be or comprise paper, card, paperboard, cardboard, reconstituted material, a plastics material, a ceramic material, a composite material, glass, a metal, or a metal alloy. In some embodiments, the support comprises a susceptor. In some embodiments, the susceptor is embedded within the material. In some alternative embodiments, the susceptor is on one or either side of the material.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

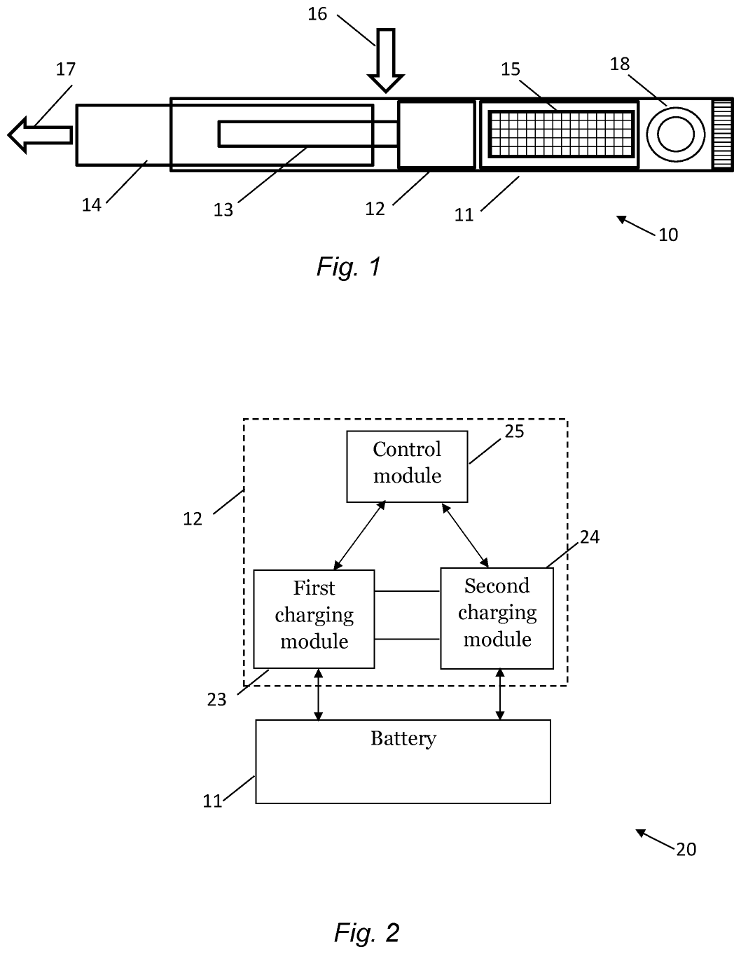

FIG. 1 is a block diagram of a non-combustible aerosol provision device, indicated generally by the reference numeral 10, in accordance with an example embodiment.

The aerosol provision device 10 comprises a battery 11, a control circuit 12, a heater 13 (or more generally an aerosol generator), a consumable 14 (e.g. a tobacco consumable, for example in the form of a tobacco stick), an antenna 15 and an induction module 18. As discussed in detail below, the antenna 15 may be used to receive radio frequency signals for use in charging the battery 11 (e.g. under the control of the control circuit 12). In addition, the antenna 15 may be used to transmit and/or receive data, for example using one of a number of protocols (e.g. Bluetooth, Wi-Fi etc.). Similarly, the induction module 18 may be used to receive electromagnetic radiation for use in charging the battery 11 (e.g. under the control of the control circuit 12).

The example antenna 15 and induction module 18 are both shown provided near the battery 11; however, one or both may be located elsewhere.

In the use of the device 10, the heater 13 is inserted into the consumable 14, such that the consumable may be heated to generate an aerosol (and tobacco flavour, in the case of a tobacco consumable) for the user. When a user inhales at the end of the consumable, as indicated by arrow 17, the air is drawn into the device 10, through an air inlet as indicated by arrow 16, then passes through the consumable, delivering the aerosol (and tobacco flavour, in the case of a tobacco consumable) to the user.

The aerosol provision device 10 is described by way of example only. Many alternative aerosol provision devices may be used in example implementations of the principles described here. For example, the device 10 may be replaced within a vaping device in which an aerosol generating material (e.g. a liquid) is heated to generate the aerosol. The principles of the present disclosure are not limited to a particular type of aerosol provision device 10 (that is to say, the aerosol provision device 10 may be arranged to aerosolise a solid, liquid or other aerosol-generating material via any suitable electrically powered or controller aerosol generator, such as a heater, a vibrating mesh, a source of irradiation, an electrically controller pressurised cannister which may include an electrically operated release valve, etc.). Moreover, as discussed in detail below, an additional charging mechanism may be provided, for example in addition to, or instead of, the induction module 18.

FIG. 2 is a block diagram of a system, indicated generally by the reference numeral 20, in accordance with an example embodiment. The system 20 comprises the battery 11 and the control circuit 12 of the aerosol provision device 10 described above.

The control circuit 12 of the system 20 comprises a first charging module 23, a second charging module 24 and a control module 25. The control circuit 12 may also be used to control the heater 13 (not shown in FIG. 2).

The first charging module 23 is configured to selectively charge the battery 11 with power obtained from a first power source. For example, the first charging module 23 may be connected to the antenna 15 and may be configured to selectively charge the battery 11 with power extracted from radio frequency signals received using the antenna 15 (if available).

Similarly, the second charging module 24 is configured to selectively charge the battery 11 with power obtained from a second power source. For example, the second charging module 24 may be connected to the induction module 18 and may be configured to selected charge the battery 11 with power obtained by the induction module 18 through electromagnetic induction (if available). The control module 25 may be configured to control the first and second charging modules, thereby controlling charging of the battery. Alternative second power sources include directed electrical contact to a power source (e.g. a battery or mains connection or a USB connection).

It should be noted that, in some example embodiments, the functionality of the control module 25 is implemented by the first charging module 23 and/or the second charging module 24. Indeed, the control module 25 may be omitted from some example embodiments. Moreover, the functionality of the first and second charging modules 23 and 24 may be provided by a single control module; for example, the first and second charging modules 23 and 24 may be omitted and their functionality implemented by the control module 25.

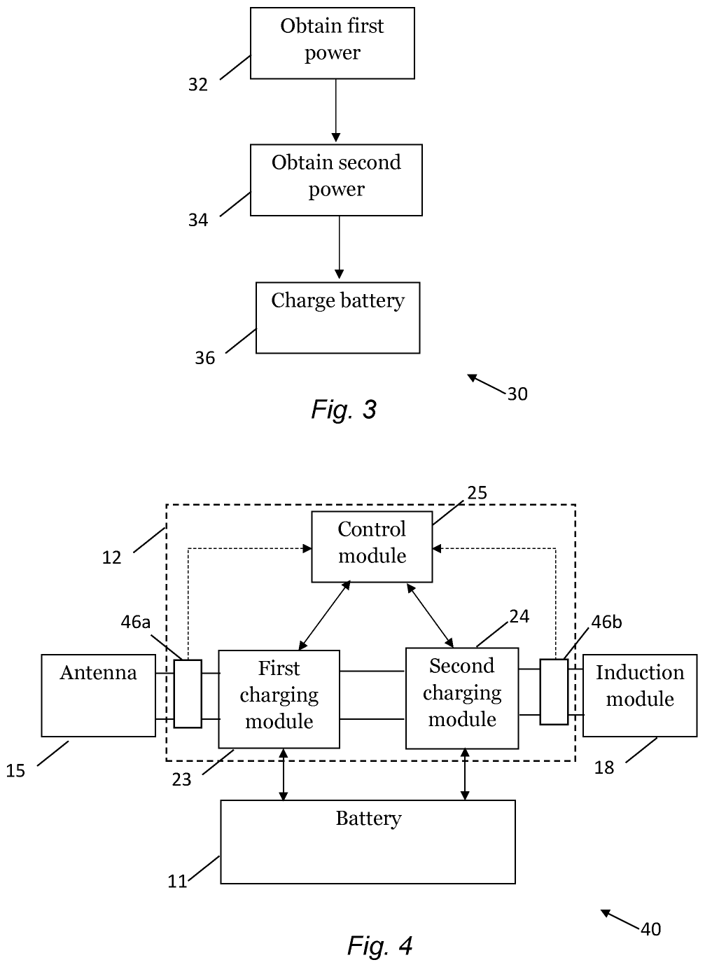

FIG. 3 is a flow chart showing an algorithm, indicated generally by the reference numeral 30, in accordance with an example embodiment.

At operation 32 of the algorithm 30, first electrical power is obtained. The first electrical power may be obtained from radio frequency signals using the antenna 15 (if available). At operation 34, second electrical power is obtained. The second electrical power may be obtained through electromagnetic induction using the induction module 18 (if available). It should be noted that the operations 32 and 34 may be carried out at the same time, or in a different order. Moreover, one or both of those operations may be omitted if power is not available (e.g. if the antenna is not receiving suitable radio frequency signals or if the induction module is not in the vicinity of a suitable charging module).

At operation 36, the battery 11 is selectively charged using the first and/or the second obtained electrical power.

FIG. 4 is a block diagram of a system, indicated generally by the reference numeral 40, in accordance with an example embodiment.

The system 40 comprises the battery 11, the control circuit 12 (including the first charging module 23, the second charging module 24 and the control module 25) of the system 20 described above. The control circuit 12 may also be used to control the heater 13 (not shown in FIG. 4). The system 40 also includes the antenna 15 and the induction module 18 of the aerosol provision device 10 described above.

The system 40 further comprises a first power detection unit 46a and a second power detection unit 46b. The first power detection unit 46a is configured to determine whether power may be obtained using the antenna 15 and the second power detection unit 46b is configured to determine whether power may be obtained using the induction module 18. The first and second power detection units may each be configured to communicate a signal indicative of the above determinations to the control module 25. It should be noted that in some example embodiments one or both of the first and second power detection units 46a and 46b may be omitted. Moreover, the induction module 18 may be replaced with an alternative source of power.

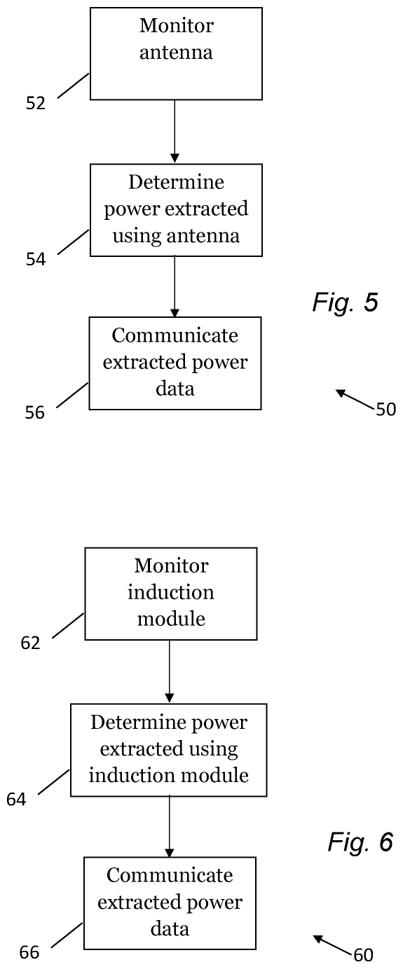

FIG. 5 is a flow chart showing an algorithm, indicated generally by the reference numeral 50, in accordance with an example embodiment. The algorithm 50 may be implemented by the first power detection unit 46a.

The algorithm 50 starts at operation 52, where the antenna is monitored by the first power detection module 46a.

At operation 54, a first the amount of power extracted (or available to be extracted) using the antenna is determined, based on the monitoring in operation 52.

At operation 56, information relating to the first amount of power is communicated to the control module 25.

FIG. 6 is a flow chart showing an algorithm, indicated generally by the reference numeral 60, in accordance with an example embodiment. The algorithm 60 may be implemented by the second power detection unit 46b.

The algorithm 60 starts at operation 62, where the induction module is monitored by the second power detection module 46b.

At operation 64, a second amount of power extracted (or available to be extracted) from the induction module is determined, based on the monitoring in operation 62.

At operation 66, information relating to the second amount of power is communicated to the control module 25.

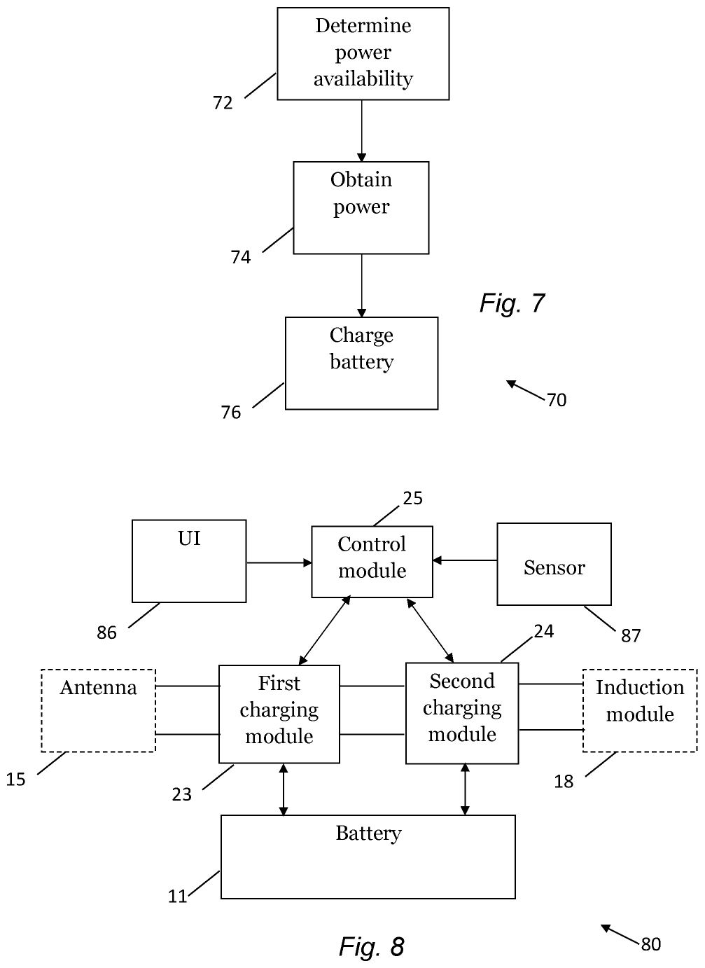

FIG. 7 is a flow chart showing an algorithm, indicated generally by the reference numeral 70, in accordance with an example embodiment.

The algorithm 70 starts at operation 72, where power availability is determined. The operation 72 may include using the first power detection unit 46a to determine whether the first charging module 23 is capable of charging the battery 11 with first electrical power from radio frequency signals using the antenna and, if so, whether the first charging module is to be used to charge the battery. The operation 72 may also include determining whether the second charging module 24 is capable of charging the battery 11 with second electrical power (e.g. power extracted through electromagnetic induction using the induction module 18) and, if so, whether the second charging module is to be used to charge the battery.

At operation 74, power is obtained. The power may be extracted by the first charging module 23 and/or the second charging module 24 described above. For example, the power may be extracted from radio frequency signals received at the antenna 15 and/or from power received through electromagnetic induction using the induction module 18.

The operation 74 is dependent on the determination made in the operation 72. The operation 74 may therefore be used to implement the operations 32 and 34 described above.

At operation 76, the battery 11 is selectively charged using power obtained in the operation 74. The operation 76 may therefore be used to implement the operation 36 described above.

FIG. 8 is a block diagram of a system, indicated generally by the reference numeral 80, in accordance with an example embodiment.

The system 80 comprises the battery 11, the first charging module 23, the second charging module 24 and the control module 25 described above. The system 80 may comprise the antenna 15 coupled to the first charging module 23 and/or the induction module 18 coupled to the second charging module 24. The system 80 may additionally comprise the first power detection unit 46a and a second power detection unit 46b described above (not shown in FIG. 8).

The system 80 further comprises a user interface 86 and a sensor 87 (such as a proximity sensor). In some example embodiments one or both of the user interface 86 and the sensor 87 may be omitted.

The user interface 86 may be provided to enable a user to select a preferential source of power. For example, the user interface may enable the user to indicate whether power should be obtained using the first charging module 23 (e.g. from the antenna 15) and/or from the second charging module 24 (e.g. from the induction module 18), if, for example, both power sources are available). The user interface 86 is in communication with the control module 25 such that the user interface can communicate a signal indicative of the above user indication to the control module. The user indication may, for example, be used in the operation 74 to determine where power is obtained from (e.g. whether one source of available power is preferred (by the user) over another).

The sensor 87 (e.g. a proximity sensor) may be configured to detect whether a charging module is in the vicinity of the induction module 18 (if provided) so that power is available through electromagnetic induction. Accordingly, the sensor 87 may be used as part of the operation 72 described above. For example, the sensor 87 may be configured to receive a wireless signal (such as a WiFi or Bluetooth) emitted for the purposes of establishing a communications link.

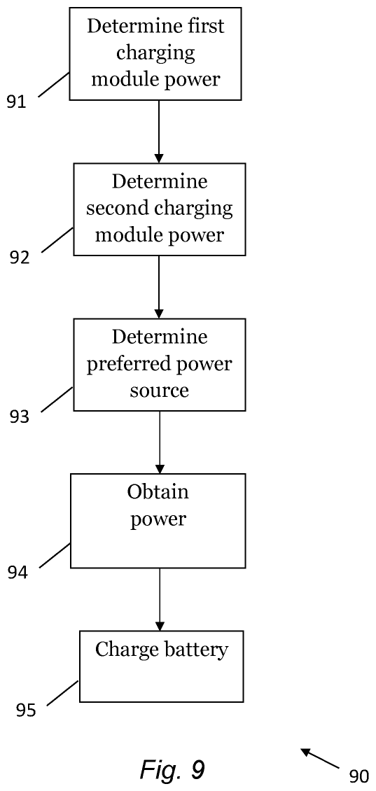

FIG. 9 is a flow chart showing an algorithm, indicated generally by the reference numeral 90, in accordance with an example embodiment.

The algorithm 90 starts at operation 91 where first charging module power is determined. The operation 91 may determine the ability of the antenna 15 to provide electrical power for charging the battery 11. The operation 91 may be implemented by the control module 25 described above, based on information received from the first power detection unit 46a.

The algorithm 90 then moves to operation 92 where second charging module power is determined. The operation 92 may determine the ability of the induction module 18 to provide electrical power for charging the battery 11. The operation 92 may be implemented by the control module 25 described above, based on information received from the second power detection unit 46b. In some example embodiments, the operation 91 may make use of an output of the sensor 87 described above.

The operations 91 and 92 may collectively be used to implement the operation 72 described above. Of course, the order of the operations 91 and 92 may be reversed, or those operations may be implemented in parallel.

At operation 93, a preferred power source is determined. For example, the control module 25 may select a preferred power source. As discussed above, a user may be able to indicate a preferred power source (e.g. using the user interface 86) and this indication may be used (or at least taken into account) when selected the preferred power source.

At operation 94, power is obtained, either from the first charging module 23 (e.g. from the antenna 15), from the second charging module 24 (e.g. from the induction module 18), or both. The operation 94 is therefore an example implementation of the operation 74 described above.

Finally, at operation 95, the battery 11 is charged with the power obtained in the operation 94. Thus, the operation 95 is an example of the operation 76 described above.

As discussed above, a number of different power sources could be used with example embodiments. For example, the induction module 18 could be replaced with an alternative charging mechanism, such as a physical connection to a battery or a mains power source.

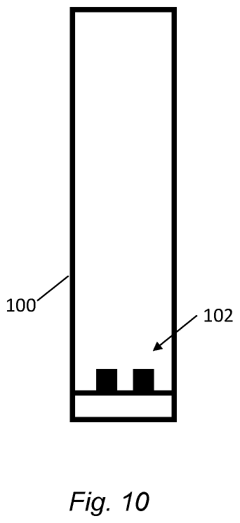

FIG. 10 is a block diagram of a charging device 100 in accordance with an example embodiment. The charging device 100 includes physical electrical connectors 102 that can be used to form an electrical connection between the aerosol provision device and the charging device 100. The second charging module 24 may be connected to a power source using the electrical connectors 102.

As discussed above, electrical power may be extracted from radio frequency (RF) signals. This may be implemented in a number of ways. For example, a receiving antenna may be provided to receive the RF signals, causing a potential difference to occur across the length of the antenna. Thus, an AC (typically sinusoidal) RF signal is obtained at the antenna. This AC signal is typically converted into a DC signal, for example using a rectifier circuit (such as a full bridge or half-bridge rectifier circuit). In some example embodiments, an impedance matching circuit is provided between the antenna and a rectifier circuit that seeks to maximise power transfer from the antenna to the rectifier. The DC electrical power output by the rectifier may, for example, be stored using a battery.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An aerosol provision device comprising:
an antenna;
a battery;
a first charging module, configured to selectively charge the battery with power extracted from radio frequency signals received using the antenna;
a second charging module, configured to selectively charge the battery with power obtained from a second source; and
a control module configured to control the first and second charging modules, thereby controlling charging of the battery.

2. The aerosol provision device as claimed in claim 1, wherein the control module is configured to determine whether the first charging module is capable of charging the battery and, if so, whether the first charging module is to be used to charge the battery.

3. The aerosol provision device as claimed in claim 1, wherein the control module is configured to determine whether the second charging module is capable of charging the battery and, if so, whether the second charging module is to be used to charge the battery.

4. The aerosol provision device as claimed in claim 1, wherein the control module is configured to determine whether to charge the battery using the first charging module, the second charging module, or both.

5. The aerosol provision device as claimed in claim 1, wherein the control module is configured to select a preferential source of power.

6. The aerosol provision device as claimed in claim 1, further comprising:
at least one power detection unit, wherein the at least one power detection unit is configured to determine whether power is obtainable using the first charging module and/or the second charging module and communicate a signal indicative of the above determination to the control module.

7. The aerosol provision device as claimed in claim 6, wherein the at least one power detection unit comprises a first power detection unit configured to:
determine a first the amount of power extracted from the first charging module; and
communicate information relating to the first amount of power to the control module.

8. The aerosol provision device as claimed in claim 6, wherein the at least one power detection unit comprises a second power detection unit configured to:
determine a second amount of power extracted from the second charging module; and
communicate information relating to the second amount of power to the control module.

9. The aerosol provision device as claimed in claim 1, further comprising:
a user interface, wherein the user interface is configured to:
enable the user to indicate whether power may be obtained using the first charging module and/or the second charging module; and
communicate a signal indicative of the above user indication to the control module.

10. The aerosol provision device as claimed in claim 9, wherein the user interface enables a user to select a preferential source of power.

11. The aerosol provision device as claimed in claim 1, further comprising an induction module, wherein the second charging module is configured to selectively charge the battery with power obtained by the induction module through electromagnetic induction.

12. The aerosol provision device as claimed in claim 11, further comprising a sensor configured to detect whether the induction module is within the vicinity of a charging module so as to receive power through electromagnetic induction.

13. The aerosol provision device as claimed in claim 12, wherein said sensor is a proximity sensor.

14. The aerosol provision device as claimed in claim 1, wherein the antenna is configured to transmit and/or receive data.

15. A method comprising:
obtaining first electrical power from radio frequency signals using an antenna of an aerosol provision device;
obtaining second electrical power from a second source; and
selectively charging a battery of the aerosol provision device using the first and/or the second obtained electrical power.

16. The method as claimed in claim 15, further comprising:
determining whether a first charging module is capable of charging the battery with the first electrical power extracted from radio frequency signals using the antenna and, if so, whether the first charging module is to be used to charge the battery.

17. The method as claimed in claim 15, further comprising:
determining whether a second charging module is capable of charging the battery with the second electrical power and, if so, whether the second charging module is to be used to charge the battery.

18. The method as claimed in claim 15, further comprising:
determining whether to charge the battery using the first obtained electrical power, the second obtained electrical power, or both.

19. The method as claimed in claim 15, further comprising:
selecting a preferential source of power.

20. The method as claimed in claim 19, further comprising:
receiving a user input indicating a preferential power source and selecting said preferential source of power accordingly.

21. The method as claimed in claim 15, wherein obtaining second electrical power from the second source comprises obtaining said second electrical power through electromagnetic induction using an induction module.

22. The method as claimed claim 21, further comprising:
determining whether power may be obtained using the antenna and/or the induction module using a power detection unit, and
communicating a signal indicative of the above determination to the control module.

23. The method as claimed in claim 22, further comprising:
monitoring the antenna and/or the induction unit;
determining an amount of power extracted by the antenna and/or the induction unit; and
communicating information relating to the extracted power to the control module.

24. The method as claimed in claim 23, further comprising:
monitoring the antenna and/or the induction unit;
determining an amount of power available to be extracted by the antenna and/or the induction unit; and
communicating information relating to the extracted power to the control module.

25. The method of claim 21, further comprising:
detecting whether the induction module is within the vicinity of a charging module so as to receive power through electromagnetic induction.

26. A computer program comprising instructions for causing an apparatus to perform the method as claimed in claim 15.
